(19) United States
(12) Patent Application Publication
(10) Pub. No.: US 2024/0195872 A1
(43) Pub. Date: Jun. 13, 2024

(54) System and method to guarantee provenance of information, system and method for granting an access to a resource

(71) Applicants: Muthaiah VENKATACHALAM, Beaverton, OR (US); Sanjay BAKSHI, Portland, OR (US); Ittai ABRAHAM, Tel Aviv (IL)

(72) Inventors: Muthaiah VENKATACHALAM, Beaverton, OR (US); Sanjay BAKSHI, Portland, OR (US); Ittai ABRAHAM, Tel Aviv (IL)

(21) Appl. No.: 18/398,210

(22) Filed: Dec. 28, 2023

Related U.S. Application Data
(60) Provisional application No. 63/585,968, filed on Sep. 28, 2023.

(51) Int. Cl. H04L 67/1097; H04L 9/40

(52) U.S. Cl. CPC H04L 67/1097; H04L 63/10

(57) ABSTRACT

A system to guarantee a provenance of information comprises a distributed storage (101) and processing circuitry (102). The processing circuitry (102) is configured to communicate with the distributed storage (101), to generate provenance information of the information, and to store the provenance information at the distributed storage (101). Transceiver circuitry (103), is configured to receive the information, to query the provenance information of the information, and to use the information if the provenance of the information indicates an expected generator of the information.

### BACKGROUND

Digital information such as data sets for artificial intelligence (AI) model training, AI models themselves and algorithms are widely available. Since AIs are largely being built on open source, provenance of digital information becomes a critical issue in the open source and AI world for creators and developers of the digital information. A non-fungible token (NFT) may be used as a unique digital identifier that is recorded on a blockchain and is used to certify ownership and authenticity typically for digital files such as art works. Even though the NFT is non-fungible, there are concerns due to a lack of interoperability across different platforms and copy of the digital information. Hence, there may be a need for improved provenance assertation and verification system or method.

### BRIEF DESCRIPTION OF THE FIGURES

Some examples of apparatuses and/or methods will be described in the following by way of example only, and with reference to the accompanying figures, in which

FIG. 1 illustrates a diagram of a system to guarantee a provenance of information;

FIG. 2 illustrates a diagram of a further example of the system to guarantee a provenance of information;

FIG. 3 illustrates a flow diagram of a method to guarantee provenance of information;

FIG. 4 illustrates a diagram of a system to grant an access to a resource;

FIG. 5 illustrates a diagram of an example of the system to grant an access to a resource; and

FIG. 6 illustrates a flow diagram of a method to grant an access to a resource;

FIG. 7 illustrates a diagram of a further example of the system to guarantee a provenance of information and to establish a smart contract; and

FIG. 8 illustrates different type of information in a digital process chain to assure provenance for.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

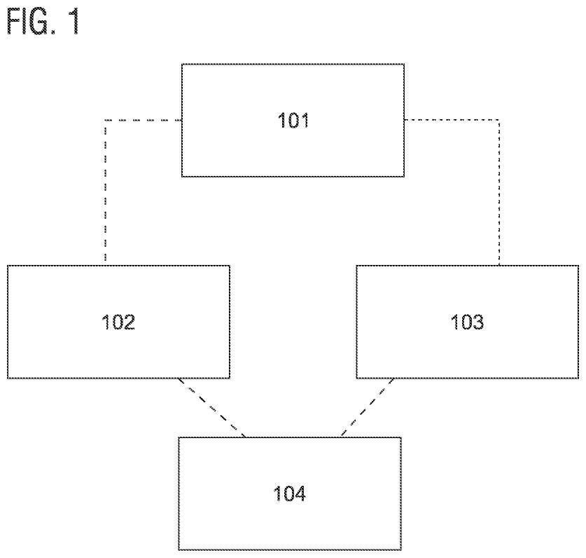

FIG. 1 shows a diagram illustrating a system to guarantee provenance of information. According to an example, the system comprises a distributed storage 101, processing circuitry 102, and transceiver circuitry 103. The distributed storage 101 may, for example, be a decentralized storage system or network based on a blockchain.

The processing circuitry 102 is configured to communicate with the distributed storage 101, and to generate provenance information of information and store the provenance information at the distributed storage 101. The information itself may be stored at a different entity 104, such as for example in a storage accessible from both, the processing circuitry 102 and the transceiver circuitry 103. As an example, the provenance information maybe a hash or an identifier to be stored at a first blockchain address on a blockchain stored in the distributed storage 101. The provenance information identifies an origin or a creator of the information to, for example, assure a user that the information is created by a person one trust or one has a business relationship with.

The transceiver circuitry 103 is configured to receive the information and to query the provenance information of the information to check the origin of the information and as to whether it was altered after creation. The transceiver circuitry 103 uses the information if the provenance information of the information indicates an expected generator of the information.

According to an example, the information comprises at least one of data, an AI model, a (program) code, and an identity.

According to an example, the transceiver circuitry 102 is optionally configured to generate a smart contract for the use of the information if the provenance information of the information indicates an expected generator of the information. The smart contract may be understood as a program stored on a blockchain, which runs when predetermined conditions are met without any involvement of intermediary entities. For example, the smart contract may define fees to be paid by an operator of the transceiver circuitry for the use of the information.

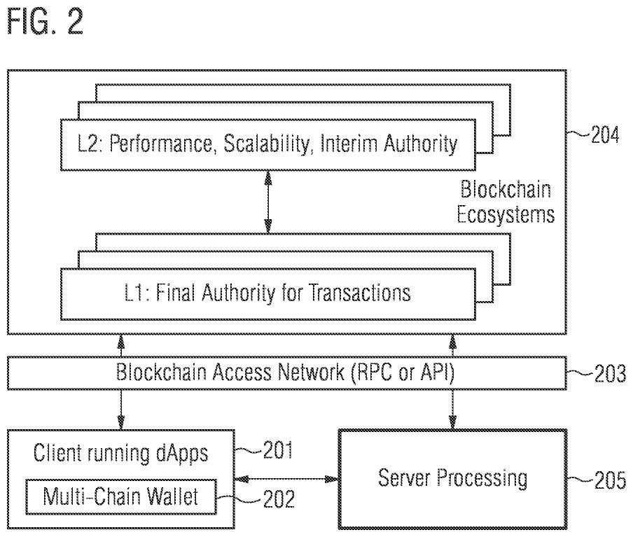

FIG. 2 illustrates a diagram of a practical implementation of entities involved in a system to guarantee provenance of information.

A blockchain 204 serves as the distributed storage and can be publicly accessed by an API 203. A client 201 comprises the transceiver circuitry. The client 201 wants to be sure that content or information generated or provided from a server 205 as an entity 104 to provide the information is originating from the expected creator. Processing circuitry configured to generate provenance information for the information provided by the server 205 may, for example, be implemented within the server 205. The client 201 may, for example, comprise a Wallet 202 operative to communicate with different implementations of distributed storages 204 in order support querying for the provenance information or to implement pay mechanisms to reward for the received information.

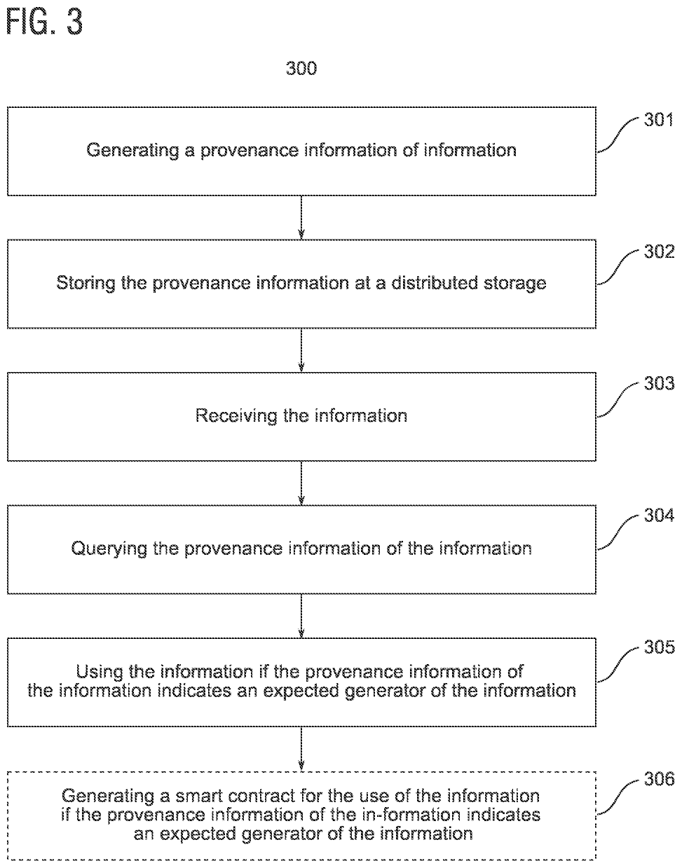

FIG. 3 illustrates a flow diagram of a method 300 to guarantee provenance of information. The method 300 comprises generating 301 a provenance information of the information and storing 302 the provenance information at a distributed storage. The distributed storage may be of any kind publicly accessible and set up such that data stored in the distributed storage (distributed ledger) cannot be compromised. One particular example for distributed storage is a blockchain.

The method further comprises receiving the information 303 and querying 304 the provenance information from the distributed storage. According to the method, the information is used if the provenance information indicates an expected generator of the information.

A user or client performing a method to guarantee provenance of information comprising at least operations 303, 304, and 305 can so be sure that the information comes from the right user.

A generator of the provenance information (which may be the creator of the information) may so provide means to assure users of the information that the information was generated by a particular creator. To this end, the generator may perform a method to provide provenance of information comprising at least actions 301 and 302.

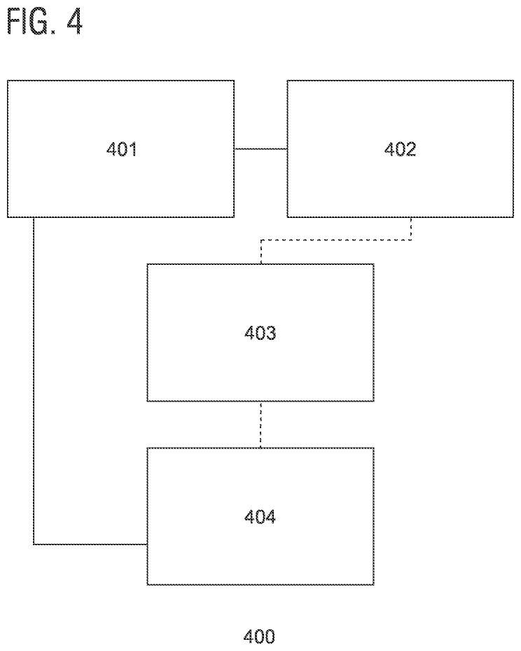

FIG. 4 illustrates a diagram of a system 400 to grant an access to a resource 401. The system comprises a distributed storage 403. A transceiver 402 which may, for example, be implemented at a requester of the resource, is configured to query an identity of a provider of the resource from a distributed storage 403. A processor 404 is coupled to the resource 401 and configured to query an identity of the requester of the resource from the distributed storage 403. The processor is configured to grant an access to the requester of the resource 401 if the queried identities of the requester and the provider correspond to expected identities of the requester and the provider. For example, the resource can be one of a data storage or data vault.

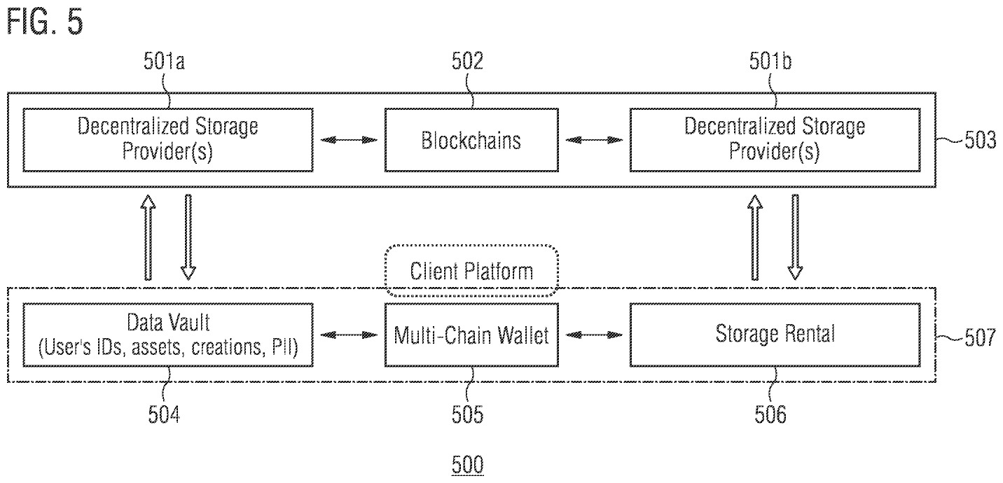

FIG. 5 illustrates a diagram of a practical implementation of entities involved in a system 500 to grant an access to a resource.

A blockchain 502 serves as the distributed storage and the resource requested is storage 506 or a data vault hosted at a client platform 507. The requested resource data storage 506 and/or a data vault 504 present in the client platform. Transceivers 501a and 501b are configured to query an identity of the client 507 as the provider of the resource from the blockchain 502. A multi chain valet 505 at the client serves as a processor configured to query an identity of the requester of the resource from the distributed storage 502. The valet 505 is configured to grant an access to the requester of the resource if the queried identities of the requester and the provider correspond to expected identities of the requester and the provider.

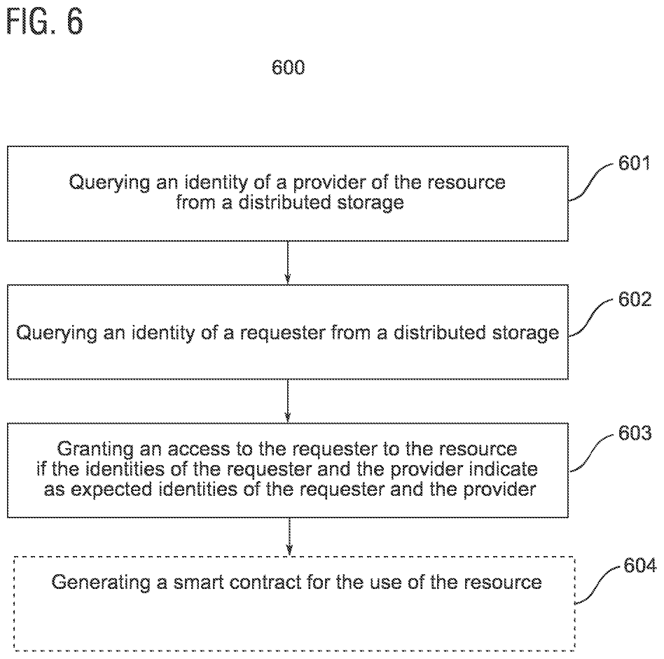

FIG. 6 illustrates a flow diagram of a method 600 to grant an access to a resource.

The method 600 comprises querying 601 an identity of a provider of the resource from a distributed storage. The method 600 further comprises querying 602 an identity of a requester from a distributed storage. Further, the method comprises granting 603 an access to the requester of the resource if the identities of the requester and the provider indicate as expected identities of the requester and the provider.

A user or client performing a method to request access to a resource comprising at least operations 601 and 603 (receiving access to the resource) can so be sure that the resource is provided by the expected (trusted) user.

A provider of a resource performing a method to grant access to a resource comprising at least operations 602 and 603 can so be sure that the resource is provided to the expected (trusted) user.

Optionally, the method may further comprise generating a smart contract (604) for the use of the resource. The smart contract may, for example, be stored in the distributed storage.

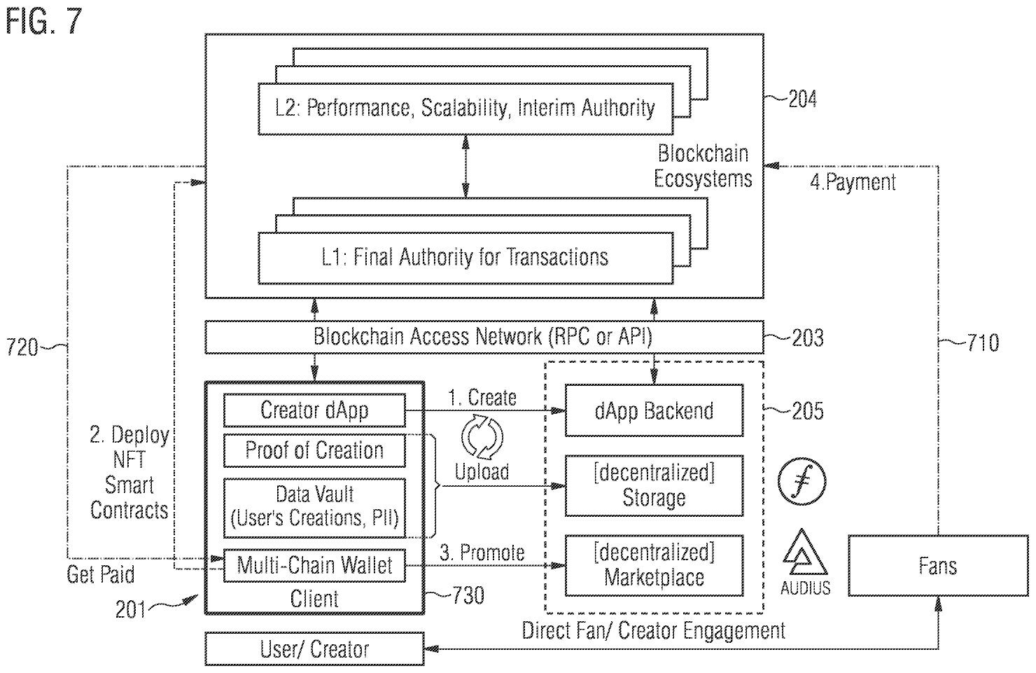

FIG. 7 illustrates a further diagram of a practical implementation of entities involved in a system to guarantee provenance of information. The principal setup has already been illustrated in FIG. 2.

Further to FIG. 2, FIG. 7 also illustrates the cashflow 710, 720, from a creator of information to a client 201 requesting information. According to the implementation illustrated in FIG. 7, the client 201 may be both, requester of information and generator of information, as illustrated by means of the interface 730 to generate provenance information.

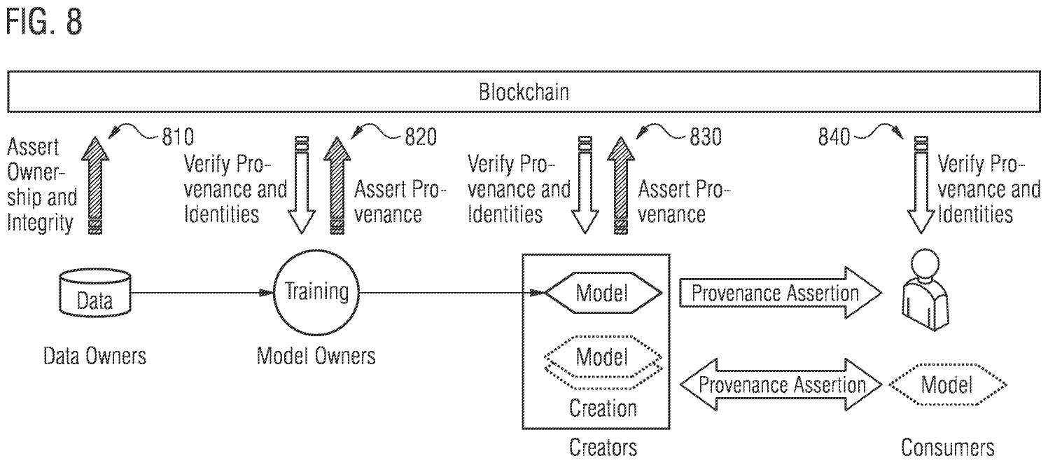

FIG. 8 illustrates different type of information in a digital process chain that one can want to prove provenance. For example, in the process chain where training data 810 is used to train a neural network 820 to come up with a trained neural network as a model 830, a user 840 of the model 830 may have interest to assure provenance for all components used to generate the used information, which is for the training data 810, neural network 820, and the model 830 itself.

In the following, some examples of the proposed concept are presented:

An example (e.g., example 1) relates to a system to guarantee a provenance of information, comprising a distributed storage, a processing circuitry, configured to communicate with the distributed storage, to generate a provenance information of the information, and to store the provenance information at the distributed storage, and a transceiver circuitry, configured to receive the information, to query the provenance information of the information, and to use the information if the provenance of the information indicates an expected generator of the information.

Another example (e.g., example 2) relates to a previous example (e.g., example 1) or to any other example, further comprising that the information comprises at least one of data, AI model, code, and identity.

Another example (e.g., example 3) relates to a previous example (e.g., example 1) or to any other example, further comprising that the transceiver circuitry is further configured to generate a smart contract for the use of the information if the provenance information of the information indicates an expected generator of the information.

An example (e.g., example 4) relates to an apparatus to provide provenance of information stored in a non-transitory memory, comprising an interface for the non-transitory memory, configured to access to the information, a communication circuitry, configured to communicate with a distributed storage, and a processing circuitry, configured to generate a provenance information for information stored in the non-transitory memory and to store the provenance information at a distributed storage.

Another example (e.g., example 5) relates to a previous example (e.g., example 4) or to any other example, further comprising that the information comprises at least one of data, AI model, code, and identity.

An example (e.g., example 6) relates to an apparatus to guarantee a provenance of information, comprising a transceiver configured to receive the information from a non-transitory memory, and a processing circuitry, configured to query the provenance information of the information from a distributed storage and to use the information if the provenance information indicates an expected generator of the information.

Another example (e.g., example 7) relates to a previous example (e.g., example 6) or to any other example, further comprising that the information comprises at least one of data, AI model, code, and identity.

Another example (e.g., example 8) relates to a previous example (e.g., example 6 or 7) or to any other example, further comprising that the transceiver further configured to generate a smart contract for the use of the information if the provenance information indicates an expected generator of the information.

An example (e.g., example 9) relates to a method to guarantee a provenance of information, comprising generating a provenance information of the information, storing the provenance information at a distributed storage, receiving the information, querying the provenance information of the information, and using the information if the provenance information indicates an expected generator of the information.

Another example (e.g., example 10) relates to a previous example (e.g., example 9) or to any other example, further comprising that the information comprises at least one of data, AI model, code, and identity.

Another example (e.g., example 11) relates to a previous example (e.g., example 9 or 10) or to any other example, further comprising generating a smart contract for the use of the information if the provenance information of the information indicates an expected generator of the information.

An example (e.g., example 12) relates to a method to guarantee a provenance of information, comprising generating a provenance information of the information, storing the provenance information at a distributed storage,

Another example (e.g., example 13) relates to a previous example (e.g., example 12) or to any other example, further comprising that the information comprises at least one of data, AI model, code, and identity.

An example (e.g., example 14) relates to a method to guarantee a provenance of information, comprising receiving the information, querying the provenance information of the information from a distributed, and using the information if the provenance information indicates as an expected generator of the information.

Another example (e.g., example 15) relates to a previous example (e.g., example 14) or to any other example, further comprising that the provenance of information comprises at least one of data, AI model, code, and identity.

Another example (e.g., example 16) relates to a previous example (e.g., example 14 or 15) or to any other example, further comprising generating a smart contract for the use of the information if the provenance information of the information indicates an expected generator of the information.

Another example (e.g., example 17) relates to a previous example (e.g., example 16) or to any other example, further comprising storing the smart contract at a distribute storage.

Another example (e.g., example 18) relates to a system for granting an access to a resource, comprising a distributed storage; a transceiver configured to query an identity of a provider of the resource from a distributed storage and to query an identity of the requester from the distributed storage; and a processor coupled to the resource, configured to grant an access to a requester of the resource if the queried identities of the requester and the provider correspond to expected identities of the requester and the provider.

Another example (e.g., example 19) relates to a previous example (e.g., example 18) or to any other example, further comprising that the resource is a data storage or data vault.

An example (e.g., example 20) relates to a method for granting an access to a resource, comprising querying an identity of a provider of the resource from a distributed storage, querying an identity of a requester from a distributed storage, and granting an access to the requester to the resource if the identities of the requester and the provider indicate as expected identities of the requester and the provider.

Another example (e.g., example 21) relates to a previous example (e.g., example 20) or to any other example, further comprising that the resource is a data storage or data vault.

Another example (e.g., example 22) relates to a computer program having a program code for, when executed by a processor, performing a method of any of examples 9 to 17 and 20 to 21.

Another example (e.g., example 23) relates to a computer readable storage medium having stored thereon a program having a program code for, when executed by a processor, performing a method of any of examples 9 to 17 and 20 to 21.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended.

Furthermore, features of a claim should also be included for any other independent claim, even if that claim is not directly defined as dependent on that other independent claim.

What is claimed is:

1. A system to guarantee a provenance of information, comprising:
a distributed storage (101);
a processing circuitry (102), configured to communicate with the distributed storage, to generate a provenance information of the information, and to store the provenance information at the distributed storage; and
a transceiver circuitry (103), configured to receive the information, to query the provenance information of the information, and to use the information if the provenance of the information indicates an expected generator of the information.

2. The system of the claim 1, wherein the information comprises at least one of data, AI model, code, and identity.

3. The system of the claim 1, wherein the transceiver circuitry (103) is further configured to generate a smart contract for the use of the information if the provenance information indicates an expected generator of the information.

4. A method (300) to guarantee a provenance of information, comprising:
Generating (301) a provenance information of the information;
Storing (302) the provenance information at a distributed storage;
receiving the information (303);
querying (304) the provenance information from the distributes storage; and
using the information (305) if the provenance information indicates an expected generator of the information.

5. The method (300) of claim 4, wherein the information comprises at least one of data, AI model, code, and identity.

6. The method (300) of claim 4, further comprising:
generating a smart contract (306) for the use of the information if the provenance information of the information indicates an expected generator of the information.

7. A system (400) for granting an access to a resource, comprising:
a distributed storage;
a transceiver configured to query an identity of a provider of the resource from a distributed storage and to query an identity of the requester from the distributed storage:
a processor coupled to the resource, configured to grant an access to a requester of the resource if the queried identities of the requester and the provider correspond to expected identities of the requester and the provider.

8. The system of claim 7, wherein the resource is a data storage or data vault.

9. The system of the claim 7, wherein the transceiver is further configured to generate a smart contract for the use of the resource.
